(19) United States
(12) Patent Application Publication
(10) Pub. No.: US 2022/0027707 A1
(43) Pub. Date: Jan. 27, 2022

(54) SUBGRAPH GUIDED KNOWLEDGE GRAPH QUESTION GENERATION

(71) Applicants: International Business Machines Corporation, Armonk, NY (US); Rensselaer Polytechnic Institute, Troy, NY (US)

(72) Inventors: Lingfei Wu, Elmsford, NY (US); Yu Chen, Troy, NY (US); Mohammed J. Zaki, Troy, NY (US)

(21) Appl. No.: 16/938,402

(22) Filed: Jul. 24, 2020

(51) Int. Cl. G06N 3/04; G06N 5/02; G06F 16/901; G06F 16/242; G06F 17/16

(52) U.S. Cl. CPC G06N 3/0454; G06N 5/02; G06F 17/16; G06F 16/244; G06F 16/9024

(57) ABSTRACT

A method, a computer program product, and a system for subgraph guided knowledge graph question generation. The method includes inputting a knowledge graph subgraph and a target answer into a long short-term memory encoder. The method also includes producing embeddings relating to the nodes and the edges. The method includes indicating the embeddings associated with the target answer. The method includes applying a graph neural network encoder computation in an iterative manner to the embeddings, with updated embeddings produced by the GNN encoder acting as initial values that are applied to the GNN encoder for a next iteration, until final state embeddings are produced. The method includes computing a graph-level embedding based on the final state embeddings and computing, by a recurrent neural network decoder, a question relating to the target answer and the knowledge graph subgraph using the graph-level embedding.

### STATEMENT REGARDING PRIOR DISCLOSURES BY THE INVENTOR OR A JOINT INVENTOR

The following disclosure us submitted under 35 U.S.C. 102(b)(1)(A):

DISCLOSURE: Toward Subgraph Guided Knowledge Graph Question Generation with Graph Neural Networks, Yu Chen, Lingfei Wu, Mohammed J. Zaki, Submitted to arXiv.org on Apr. 13, 2020, pages: 12.

### BACKGROUND

The present disclosure relates to knowledge question generation, and more specifically, to generating questions using knowledge graph subgraphs and target answers.

The task of question generation generates natural language questions based on a given form of data (e.g., knowledge graphs, tables, text, images). Knowledge graph subgraphs are graphs constructed from semi-structured knowledge or harvested from the web with a combination of statistical and linguistic methods. A knowledge graph's utility lies within the amount of knowledge maintained by the graph as well as the correctness of such knowledge. Refinement methods, such as adding knowledge to the graph, or identifying erroneous pieces of information can be used to increase the utility of knowledge graphs.

Knowledge graph question generation aims to generate natural language questions for a given form of data such as text, images, and knowledge graphs. A common technique of knowledge graph question generation involves generating sample questions from a single triple stored in a knowledge graph. This technique typically applies a sequence-to-sequence model with a copy mechanism for translating either a keyword list or a triple into a natural language question.

### SUMMARY

Embodiments of the present disclosure include a computer-implemented method for subgraph guided knowledge graph question generation. The computer-implemented method includes inputting a knowledge graph subgraph and a target answer into a long short-term memory encoder. The knowledge graph subgraph is a collection of entities and predicates relating to a domain and represented as nodes for the entities and edges for the predicates with the target answer being an entity within the collection of entities. The computer-implemented method also includes producing, by the long short-term memory encoder, embeddings relating to the nodes and the edges. Each of the nodes and the edges in the subgraph is an embedding represented as an initial vector in an embedding space. The computer-implemented method further includes indicating the embeddings associated with the target answer. The computer-implemented method also includes applying a graph neural network encoder computation in an iterative manner to the embeddings, with updated embeddings produced by the graph neural network encoder acting as initial values that are applied to the graph neural network encoder for a next iteration, until final state embeddings are produced. The computer-implemented method also includes generating a graph-level embedding based on the final state embeddings and inputting the graph-level embedding into a recurrent neural network decoder. The computer-implemented method further includes computing, by the recurrent neural network decoder, a question relating to the target answer and the knowledge graph subgraph.

Additional embodiments of the present disclosure include a computer program product for subgraph guided knowledge graph question generation, which can include a computer-readable storage medium having program instructions embodied therewith, the program instructions executable by a processor to cause the processor to perform a method. The method includes inputting a knowledge graph subgraph and a target answer into a long short-term memory encoder. The knowledge graph subgraph is a collection of entities and predicates relating to a domain and represented as nodes for the entities and edges for the predicates with the target answer being an entity within the collection of entities. The method also includes producing, by the long short-term memory encoder, embeddings related to the nodes and the edges. Each of the nodes and the edges in the subgraph is an embedding represented as an initial vector in an embedding space. The method further includes indicating the embeddings associated with the target answer. The method also includes applying a graph neural network encoder computation in an iterative manner to the embeddings, with updated embeddings produced by the graph neural network encoder acting as initial values that are applied to the graph neural network encoder for a next iteration, until final state embeddings are produced. The method also includes generating a graph-level embedding based on the final state embeddings and inputting the graph-level embedding into a recurrent neural network decoder. The further includes computing, by the recurrent neural network decoder, a question relating to the target answer, and the knowledge graph subgraph.

Further embodiments are directed to a graph-to-sequence system for subgraph guided knowledge graph question generation and configured to perform the methods described above. The present summary is not intended to illustrate each aspect of, every implementation of, and/or every embodiment of the present disclosure.

### BRIEF DESCRIPTION OF THE DRAWINGS

These and other features, aspects, and advantages of the embodiments of the disclosure will become better understood with regard to the following description, appended claims, and accompanying drawings where:

FIG. 1 is a block diagram illustrating a graph-to-sequence model, in accordance with embodiments of the present disclosure.

FIG. 2 is a flow diagram of a subgraph guided knowledge graph question generation process, in accordance with embodiments of the present disclosure.

FIG. 3 is a high-level block diagram illustrating an example computer system that may be used in implementing one or more of the methods, tools, and modules, and any related functions, described herein, in accordance with embodiments of the present disclosure.

FIG. 4 depicts a cloud computing environment, in accordance with embodiments of the present disclosure.

FIG. 5 depicts abstraction model layers, in accordance with embodiments of the present disclosure.

While the present disclosure is amenable to various modifications and alternative forms, specifics thereof have been shown by way of example, in the drawings and will be described in detail. It should be understood, however, that the intention is not to limit the particular embodiments described. On the contrary, the intention is to cover all modifications, equivalents, and alternatives falling within the scope of the present disclosure. Like reference numerals are used to designate like parts in the accompanying drawings.

### DETAILED DESCRIPTION

The present disclosure relates to knowledge question generation, and more specifically, to generating questions using knowledge graph subgraphs and target answers. While the present disclosure is not necessarily limited to such applications, various aspects of the disclosure may be appreciated through a discussion of various examples using this context.

The task of question generation generates natural language questions based on a given form of data (e.g., knowledge graphs, tables, text, images), where the generated questions are answerable from the input data. Older question generation (QG) using KGs used a template-based approach that required manual input and had low generalizability and scalability. More common approaches, however, use sequence-to-sequence (Seq2Seq) based neural architectures that do not require manually-designed templates and are end-to-end trainable.

Seq2Seq models employ neural networks that transform a given sequence of elements, such as the sequence of words in a sentence, into another sequence. Long-Short-Term-Memory (LSTM)-based models are a type of Seq2Seq model that produces meaning to a sequence while remembering/forgetting parts of the sequence deemed important/unimportant. Sentences, for example, are sequence-dependent since the order of the words determines the understanding of the sentence. As such, an LSTM model can parse the sentence to determine the important information within the sentence. Regarding KG question generation, Seq2Seq models generate questions from a single triple as they employ a recurrent neural network (RNN)-based encoder.

Transformer-based encoder-decoder models allow encoding of a KG subgraph to generate multi-hop questions. This technique transforms one sequence into another sequence through the use of an encoder and decoder and does not employ an RNN. Transformers, unlike RNNs, do not require that the sequence be processed in the order. As such, if the sequence is in the form of natural language, the transformer does not need to process the beginning of a sentence before it processes the end. This feature allows for parallelization during training.

Limitations on question generation remain, however, as current implementations only allow for simple question generation or do not allow for KGs to be used as input. Seq2Seq models focus on generating simple questions from a single triple. These models typically employ RNN-based encoders that cannot handle graph-structured data. Transformer models, while being able to input graph-structured data, treat KG subgraphs as a set of triples. The result being that transformer models do not distinguish between entities and relations while modeling the graph and do not utilize the explicit connections among triples.

KG question generation poses unique challenges when attempting to generate questions using machine reading comprehension techniques. One of the challenges is how to learn a representation of a KG subgraph that can provide relevant information to a model. This is due to KG subgraphs having complex underlying structures such as node attributes and multi-relation edges, where the nodes and/or edges may consist of multiple words that can be difficult for a model to capture. Another challenge is developing a model that can automatically learn a mapping between a subgraph and a natural language question. The model should be able to analyze unusual nodes or edge information that are related to the generated questions. Another challenge in KG question generation is how to effectively leverage the answer information to provide context for the question generated.

Embodiments of the present disclosure may overcome the above and other problems by using a graph-to-sequence (Graph2Seq) model for subgraph guided question generation using KGs. By doing so, the Graph2Seq model can learn a mapping between a subgraph and a natural language question. The Graph2Seq model also extends a graph neural network (GNN) encoder to make it able to process directed and multi-relational KG subgraphs in order to learn a representation of a KG subgraph capable of providing relevant information to the model.

The Graph2Seq model can employ bidirectional graph embeddings and can exploit two different graph encoders to effectively analyze KG subgraphs with directed and multi-relation edges. Additionally, an RNN decoder is used with a copy mechanism allowing an entire node attribute to be borrowed from the inputted KG subgraph when generating an output question.

Embodiments of the disclosure include an encoding module configured to encode both nodes and edges in a KG subgraph by applying two bidirectional LSTMs to encode their associated textual names. One LSTM is used to encode the node, and another is used for the edges. The concatenation of the last forward and backward hidden states of the bidirectional LSTMs are used as the initial embeddings for the nodes as well as the edges. In some embodiments, the encoding module concatenates initial vector representations of a node/edge with an answer markup vector. The answer markup vector represents the answer information, and by concatenating the vectors, each initial vector indicates whether it is an answer or not.

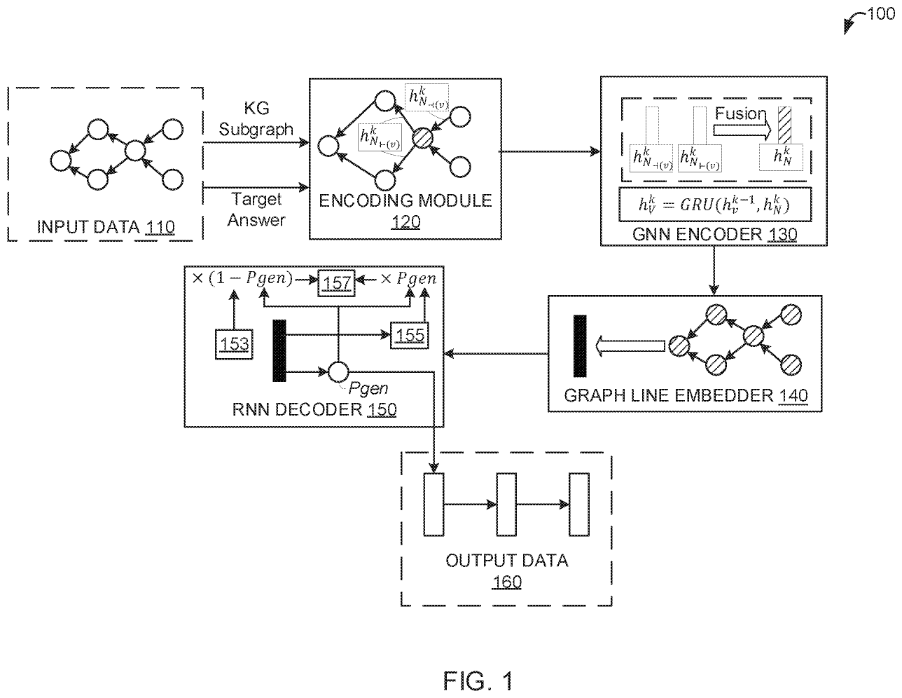

Referring now to FIG. 1, shown is a high-level block diagram of a Graph2Seq model 100 for subgraph guided knowledge graph question generation. The Graph2Seq model 100 includes input data 110, an encoding module 120, a GNN encoder 130, a graph line embedder 140, an RNN decoder 150, and output data 160.

The input data 110 is data inputted into the Graph2Seq model 100 that is used to generate a knowledge graph question. The input data includes a knowledge graph subgraph and a target answer. In some embodiments, knowledge graph subgraphs are graphs that represent the relationships between entities for a given domain. In a knowledge graph (KG), nodes represent entities, edge labels represent types of relations, and edges represent existing relationships between two entities. Subgraphs can also represent the relationship between entities in an entity subclass. An entity may represent a person (e.g., Thomas J. Watson), a place (e.g., Seattle, Texas, a street, address, etc.), or thing (e.g., book, label, monitor, attorney, paper, tree, etc.) By way of example, but not by limitation, an entity may be an organization, a political body, a business, a governmental body, a date, a number, a letter, an idea, or any combination thereof.

The target answer can be an entity within the collection of entities represented by the knowledge graph subgraph. Additionally, an entity may be associated with an entity class. An entity class may represent a categorization, type, or classification of a group or notional model of entities. For example, an entity class may include “person,” “racecar driver,” “species,” “monument,” “president,” and the like. An entity class may also be associated with one or more subclasses. A subclass can reflect a class of entities subsumed in a larger class. For example, the classes “racecar driver” and “president” may be subclasses of the class “person” because all racecar drivers and presidents are human beings. As used herein, the term “entity” may be associated with or refer to an entity class, subclass, instance thereof, a standalone entity, or any other entity consistent with the disclosed embodiments.

Entities can also be associated with one or more entity attributes and/or object attributes. An entity attribute may reflect a property, trait, characteristic, quality, or element of an entity class. Entity classes can share a common set of entity attributes. For example, the entity “person” may be associated with entity attributes “birth date,” “place of birth,” “gender,” “age,” and the like. In another example, the entity “professional sports team” may be associated with entity attributes such as “location,” “annual revenue,” “roster,” and the like. As used herein, “node attribute” may be associated with or refer to the entity attributes of an entity represented as a node in a KG.

A context may reflect a lexical construction or representation of one or more words (e.g., a word, phrase, clause, sentence, paragraph) imparting meaning to one or more words (e.g., an entity) in its proximity. A context may be represented as an n-gram. An n-gram reflects a sequence of n-words, where n is a positive integer. For example, a context may include 1-gram such as “is,” “was,” or “has.” Additionally, contexts may include 3-grams such as “was born on,” “is married to,” “has been to.” As described herein, an n-gram represents any such sequence, and two n-grams need not have the same number of words. For example, “scored a goal” and “in the final minute” may constitute n-grams, despite containing a different number of words.

A context may also indicate the potential presence of one or more entities. The one or more potential entities specified by a context may be herein referred to as “context classes” or “context entities,” although these designations are for illustrative purposes only and are not intended to be limiting. Context classes can reflect a set of classes typically arising in connection with (e.g., having a lexical relationship with) the context. In some embodiments, “context classes” may reflect specific entity classes. For example, the context “is married to” may be associated with a context class of entity “person,” because the context “is married to” usually has a lexical relationship to human beings (e.g., has a lexical relationship to instances of the “person” class).

The encoding module 120 is a component of the Graph2Seq model 100 configured to produce embeddings relating to the nodes and edges of an inputted KG subgraph. The encoding module 120 can encode input data 110 into fixed-length vectors, which the Graph2Seq model 100 can understand. Conventional word representation and pre-trained contextualized representation techniques can be used to produce the embeddings. Additionally, to encode semantic and linguistic information, multiple granularity, which fuses word-level embeddings with character-level embeddings, part-of-speech, name entity, word frequency, question category, and so on, can also be used. In some embodiments, two bidirectional LSTMs are used to encode the input data 110. One LSTM can be used to encode the nodes and another one for the edges. The concatenation of the last forward and backward hidden states of the bidirectional LSTMs can be used as the initial embeddings for the nodes as well as the edges.

Conventional word representation techniques include, for example, One-Hot and distributed word representation. The One-Hot method represents words with binary vectors, and its size is the same as the number of words in the dictionary being used. In the vectors, one position is 1, corresponding to the word, while the others are 0. The distributed word representation method encodes words into continuous low-dimensional vectors. Closely related words encoded by these methods are close to each other in a vector space, which reveals a correlation of words. Distributed word representation techniques include, for example, Word2Vec and GloVe.

Pre-trained contextualized word representation techniques include context vectors (CoVE), embeddings from language models (ELMo), generative pre-training (GPT), and bidirectional encoder representation from transformers (BERT). Pre-trained contextualized word representation techniques, such as those listed above, are typically pre-trained with a large corpus in advance and then directly used as conventional word representations or trained according to the specific tasks.

Multiple granularity techniques include character embeddings, part-of-speech tags, name-entity tags, binary feature of exact match (EM), and query-category. These techniques can incorporate fine-grained semantic information into word representations. For example, character embeddings represent words at the character level. Each character in a word is embedded into a fixed-dimension vector, which is fed into a CNN. After max-pooling the entire width, the output of the CNN are embeddings at the character level. In addition, character embeddings can be encoded with bidirectional LSTMs. For each word, the outputs of the last hidden state are considered to be its character-level representation. Word-level and character-level embeddings can be combined dynamically with a gating mechanism in place of a simple concatenation to mitigate the imbalance in word frequency.

In some embodiments, the encoding module 120 associates the answer from the input data 110 to the nodes and edges in the KG. The answer can be represented as a learnable markup vector that can indicate whether the node/edge is an answer or not. The output of the encoding module 120 can be a concatenation of the output vector and the answer markup vector that represents an embedding for each node or edge.

The GNN encoder 130 is a component of the Graph2Seq model configured to produce final state embeddings from embeddings produced by the encoding module 120. In some embodiments, the GNN encoder 130 is a bidirectional gated graph neural network (BiGGNN) which extends a GGSNN by learning node embeddings from both incoming and outgoing directions in an interleaved fashion when processing a directed graph. The BiGGNN can fuse intermediate node embeddings from both directions at every iteration.

By way of example, but not by limitation, embedding hᵥ⁰ for a node v is initialized to xᵥ that is a concatenation of the output produced by the encoding module 120 and an answer markup vector. Similar to that of a GGSNN, the GNN encoder 130 can perform message passing across graphs for a fixed number of iterations, with the same set of network parameters at each iteration. At each iteration of computation, for every node in the KG subgraph, the GNN encoder 130 applies an aggregation function that takes as input a set of incoming (or outgoing) neighboring node vectors and outputs a backward (or forward) aggregation vector.

In some embodiments, the GNN encoder 130 aggregates neighborhood information using average aggregator equations 1a and 1b as defined below:

h_{N}_{_{┤(v)}}^{k}=AVG({hᵥ^{k-1}}∪{hᵤ^{k-1},∀u∈N_{┤(v)}}) Equation 1a

h_{N}_{_{├(v)}}^{k}=AVG({hᵥ^{k-1}}∪{hᵤ^{k-1},∀u∈N_{├(v)}}) Equation 1b

Where h_{N}_{ᵥ}^{k} represents an aggregated embedding for a node v that is initialized to xᵥ that is a concatenation of the output produced by the encoding module 120 and an answer markup vector. As shown, in Equations 1a and 1b, for each node v in the KG subgraph, the average aggregation function AVG( ) takes as input a set of incoming (or outgoing) neighboring node embeddings, as well as the node embedding of node v itself, and outputs the average of those node embeddings as the aggregated embedding. So at each iteration of GNN computation, for each node, there will be two aggregated embeddings, one for the incoming direction, and the other for the outgoing direction.

In some embodiments, the GNN encoder 130 extends the BiGGNN to explicitly incorporate edge embeddings when conducting message passing. Specifically, equations 1a and 1b can be rewritten as equation 1c and 1d defined below:

h_{N}_{_{┤(v)}}^{k}=AVG({hᵥ^{k-1}}∪{ƒ([hᵤ^{k-1};eᵤᵥ]),∀u∈N_{┤(v)}}) Equation 1c

h_{N}_{_{├(v)}}^{k}=AVG({hᵥ^{k-1}}∪{ƒ([hᵤ^{k-1};eᵤᵥ]),∀u∈N_{├(v)}}) Equation 1 d

Where ƒ is a nonlinear function (i.e., linear projection+ReLU) applied to the concatenation of hᵤ^{k-1} and eᵤᵥ, where eᵤᵥ is the embedding of the edge connection node u and v. Equations 1c and 1d extend Equations 1a and 1b by incorporating an additional edge embedding eᵤᵥ for every pair of nodes u and v when performing the average aggregation.

The GNN encoder 130 is further configured to fuse the node embeddings aggregated from both directions at every hop using equation 2 defined below:

h_{N}_{₍ᵥ₎}^{k}=FUSE(h_{N}_{_{┤(v)}}^{k},h_{N}_{_{├(v)}}^{k}) Equation 2

Where the function is computed as a gated sum of two information sources using equation 3 defined below:

FUSE(a,b)=z⊙a+(1−z)⊙b,z=σ(W_{z}[a;b;a⊙b;a−b]+b_{z}) Equation 3

Where ⊙ represents the component-wise multiplication, a represents a sigmoid function, and z represents a gating vector.

The GNN encoder 130 is further configured to use a gated recurrent unit (GRU) to update the node embeddings by incorporating the aggregation information. In some embodiments, the GNN encoder 130 incorporates the aggregation information using equation 4 defined below:

hᵥ^{k}=GRU(hᵥ^{k-1},h_{N}_{₍ᵥ₎}^{k}) Equation 4

After n hops of GNN computation, where n is a hyperparameter, the GNN encoder 130 obtains a final state embedding hᵥⁿ for a node v. In this formulation, when the reset gate is close to 0, the hidden state is forced to ignore the previous hidden state and reset with the current input only. This effectively allows the hidden state to drop any information that is found to be irrelevant later in the future.

The GNN encoder 130 is further configured to convert multi-relational KG subgraphs into a Levi graph in order to apply regular GNNs without modification. The GNN encoder 130 can convert the muli-relational KG subgraphs into Levi graphs by treating all edges in the original graph as new nodes and add new edges connection to the original nodes and the new nodes that results in a bipartite graph. For example, in a KG subgraph, a triple “Mario Siciliano, place of birth, Rome,” where entities “Mario Siciliano” and “Rome” are nodes and the predicate “place of birth” is an edge, can be converted to “Mario Siciliano→place of birth→Rome,” where “place of birth” becomes a new node, and → indicates a new edge connecting an entity and a predicate.

The graph line embedder 140 is a component of the Graph2Seq model 100 configured to produce a graph-level embedding by applying a linear projection to the node embeddings, and then by applying max-pooling over all node embeddings to get a d-dim vector [symbol] . Linear projection is a linear transformation from a vector space to itself. Whenever a linear transformation is applied twice to any value, it gives the same result as if it were applied once. The graph line embedder 140 can apply max pooling to help alleviate over-fitting by providing an abstracted form of the representation. Additionally, max-pooling can reduce the computation cost by reducing the number of parameters to learn and provides basic translation invariance to the internal representation.

The RNN decoder 150 is a component of the Graph2Seq model 100 configured to produce output data 160 based on an inputted graph-level embedding. The RNN decoder 150 can take the graph-level embedding followed by two separate fully-connected layers as initial hidden states (i.e., c₀ and s₀) and the node embeddings {hᵥⁿ, ∀v∈ [symbol] } as the attention memory 153. At each decoding step, an attention mechanism of the RNN decoder 150 learns to attend to the most relevant nodes in the input graph and computes a context vector based on the current decoding state, the current coverage vector, and the attention memory 153.

When generating a natural language question (output data 160) from a KG subgraph, the question can directly mention entity names that are from the input KG subgraph (input data 110) without the need to rephrase them. To do so, the RNN decoder 150 is further configured to extend a regular word-level copying mechanism that allows copying node attributes (i.e., node names) from the input graph. At each step of decoding, the generation probability p_{gen}∈[0,1] 157 is calculated from the context vector, the decoder state, and the decoder input. Next, p_{gen} can be used as a soft switch to choose between generating a word from the vocabulary 155 or by copying a node attribute from the input graph.

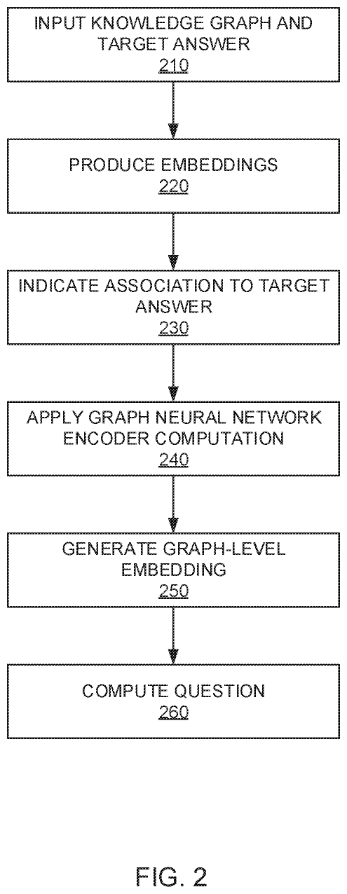

FIG. 2 is a flow diagram illustrating a process 200 of subgraph guided knowledge graph question generation, in accordance with embodiments of the present disclosure. The process 200 begins by inputting a KG subgraph and a target answer into the encoding module 120. This is illustrated at step 210. The KG subgraph can represent the relationships between entities for a given domain. Within the KG subgraph, nodes represent entities, edge labels represent types of relations, and edges represent existing relationships between two entities. Additionally, the target answer can be an entity within the collection of entities represented by the KG subgraph. For example, if the KG subgraph includes of a collection of entities that are former United States presidents, then the target answer can be one of the former presidents (i.e., George Washington, Abraham Lincoln, Theodore Roosevelt).

The encoding module 120 produces embeddings relating to the nodes and the edges of the KG subgraph. This is illustrated at step 220. As used herein, an “embedding” is a low-dimensional, learned continuous vector representation of discrete variables. Embeddings can be used in finding nearest neighbors in an embedding space, as input into the GNN encoder 130, and as a visual representation of concepts and relations between categories. The embeddings can form the parameters, or weights, of the Graph2Seq model 100, which can be adjusted to minimize loss of a task. The encoding module 120 can encode the nodes and edges into fixed-length vectors using various techniques. These techniques include, for example, conventional word representation, pre-trained contextualized representation, and multiple granularity.

The encoding module 120 indicates an association between the target answer from the input data 110 to the nodes and edges in the KG subgraph. This is illustrated at step 230. The answer can be represented as a learnable markup vector that can indicate whether the node/edge is an answer or not. The output of the encoding module 120 can be a concatenation of the output vector and the answer markup vector that represents an embedding for each node or edge.

The GNN encoder 130 iteratively applies a GNN computation to the embeddings produced by the encoding module 120. This is illustrated at step 240. In some embodiments, the GNN encoder 130 is a BiGGNN that learns node embeddings from both incoming and outgoing directions in an interleaved fashion when processing the KG subgraph. The BiGGNN can perform message passing across graphs for a fixed number of iterations, with the same set of network parameters shared at each iteration. During each iteration of GNN computation, for every node in the KG subgraph, the GNN encoder 130 applies an aggregation function (i.e., equation 1a and 1b) that takes as input a set of incoming (or outgoing) neighboring node vectors and outputs a backward (or forward) aggregation vector.

Additionally, each node embedding can be fused (i.e., using equation 2) with the aggregation vector from both directions at every iteration. Once fused, a GRU can be used to update the node embeddings by incorporating the aggregation information (i.e., using equation 4). After n iterations of GNN computation, where n is a hyperparameter, a final state embedding is produced for each node.

The graph line embedder 140 generates a graph-level embedding from the final state embeddings produced by the GNN encoder 130. This is illustrated at step 250. The graph line embedder 140 can produce the graph-level embedding by applying a linear projection and max-pooling to the final state embeddings. First, a linear projection is applied to the final state embeddings, and then the graph line embedder 140 can apply max pooling over all the final state node embeddings to get a graph-level embedding.

The RNN decoder 150 computes a question using the graph-level embedding. This is illustrated at step 260. The RNN decoder 150 can take the graph-level embedding followed by two separate fully-connected layers as initial hidden states (i.e., c₀ and s₀) and the node embeddings {hᵥⁿ, ∀v∈ [symbol] } as the attention memory 153. At each decoding step, an attention mechanism of the RNN decoder 150 learns to attend to the most relevant nodes in the input graph and computes a context vector based on the current decoding state, the current coverage vector, and the attention memory 153. The RNN decoder 150 can extend a regular word-level copying mechanism that allows copying node attributes (i.e., node names) from the input graph. At each step of decoding, the generation probability p_{gen}∈[0,1] 157 is calculated from the context vector, the decoder state, and the decoder input. Next, p_{gen} can be used as a soft switch to choose between generating a word from the vocabulary 155 or by copying a node attribute from the input graph.

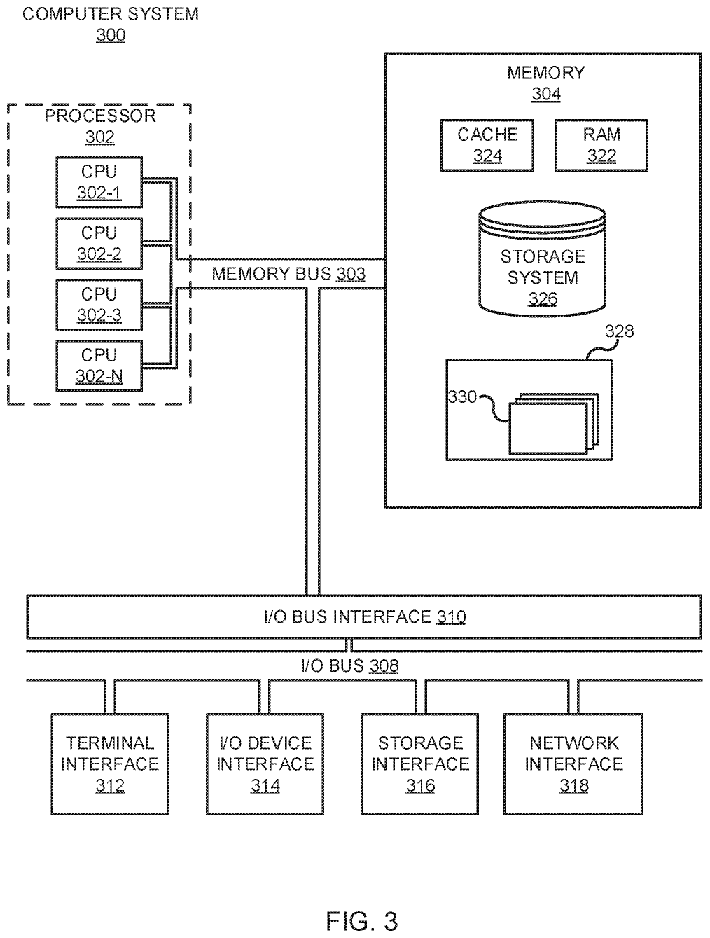

Referring now to FIG. 3, shown is a high-level block diagram of an example computer system 300 (e.g., the Graph2Seq model 100) that may be used in implementing one or more of the methods, tools, and modules, and any related functions, described herein (e.g., using one or more processor circuits or computer processors of the computer), in accordance with embodiments of the present disclosure. In some embodiments, the major components of the computer system 300 may comprise one or more processors 302, a memory 304, a terminal interface 312, an I/O (Input/Output) device interface 314, a storage interface 316, and a network interface 318, all of which may be communicatively coupled, directly or indirectly, for inter-component communication via a memory bus 303, an I/O bus 308, and an I/O bus interface 310.

The computer system 300 may contain one or more general-purpose programmable central processing units (CPUs) 302-1, 302-2, 302-3, and 302-N, herein generically referred to as the processor 302. In some embodiments, the computer system 300 may contain multiple processors typical of a relatively large system; however, in other embodiments, the computer system 300 may alternatively be a single CPU system. Each processor 301 may execute instructions stored in the memory 304 and may include one or more levels of on-board cache.

The memory 304 may include computer system readable media in the form of volatile memory, such as random-access memory (RAM) 322 or cache memory 324. Computer system 300 may further include other removable/non-removable, volatile/non-volatile computer system storage media. By way of example only, storage system 326 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, the memory 304 can include flash memory, e.g., a flash memory stick drive or a flash drive. Memory devices can be connected to memory bus 303 by one or more data media interfaces. The memory 304 may include at least one program product having a set (e.g., at least one) of program modules that are configured to carry out the functions of various embodiments.

Although the memory bus 303 is shown in FIG. 3 as a single bus structure providing a direct communication path among the processors 302, the memory 304, and the I/O bus interface 310, the memory bus 303 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 310 and the I/O bus 308 are shown as single respective units, the computer system 300 may, in some embodiments, contain multiple I/O bus interface units, multiple I/O buses, or both. Further, while multiple I/O interface units are shown, which separate the I/O bus 308 from various communications paths running to the various I/O devices, in other embodiments some or all of the I/O devices may be connected directly to one or more system I/O buses.

In some embodiments, the computer system 300 may be a multi-user mainframe computer system, a single-user system, or a server computer or similar device that has little or no direct user interface but receives requests from other computer systems (clients). Further, in some embodiments, the computer system 300 may be implemented as a desktop computer, portable computer, laptop or notebook computer, tablet computer, pocket computer, telephone, smartphone, network switches or routers, or any other appropriate type of electronic device.

It is noted that FIG. 3 is intended to depict the major representative components of an exemplary computer system 300. In some embodiments, however, individual components may have greater or lesser complexity than as represented in FIG. 3, components other than or in addition to those shown in FIG. 3 may be present, and the number, type, and configuration of such components may vary.

One or more programs/utilities 328, each having at least one set of program modules 330 (e.g., the Graph2Seq model 100), may be stored in memory 304. The programs/utilities 328 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 328 and/or program modules 330 generally perform the functions or methodologies of various embodiments.

It is to be understood that although this disclosure includes a detailed description on cloud computing, implementation of the teachings recited herein is not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

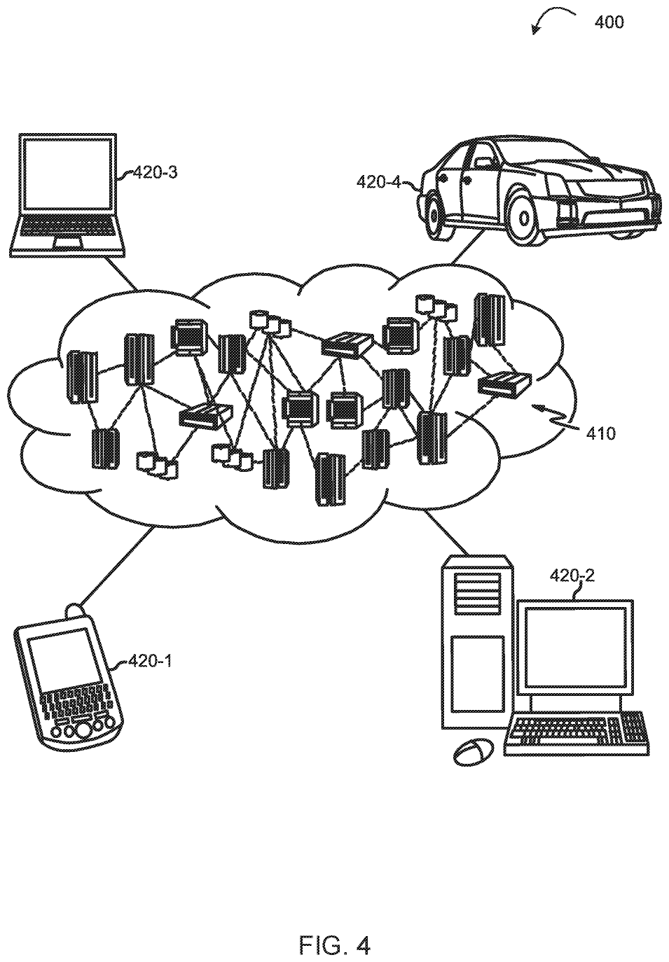

Referring now to FIG. 4, illustrative cloud computing environment 400 is depicted. As shown, cloud computing environment 400 includes one or more cloud computing nodes 410 with which local computing devices used by cloud consumers, such as, for example, personal digital assistant (PDA) or cellular telephone 420-1, desktop computer 420-2, laptop computer 420-3, and/or automobile computer system 420-4 may communicate. Nodes 410 may communicate with one another. They may be grouped (not shown) physically or virtually, in one or more networks, such as Private, Community, Public, or Hybrid clouds as described hereinabove, or a combination thereof. This allows cloud computing environment 400 to offer infrastructure, platforms and/or software as services for which a cloud consumer does not need to maintain resources on a local computing device. It is understood that the types of computing devices 420-1 to 420-4 shown in FIG. 4 are intended to be illustrative only and that computing nodes 410 and cloud computing environment 400 can communicate with any type of computerized device over any type of network and/or network addressable connection (e.g., using a web browser).

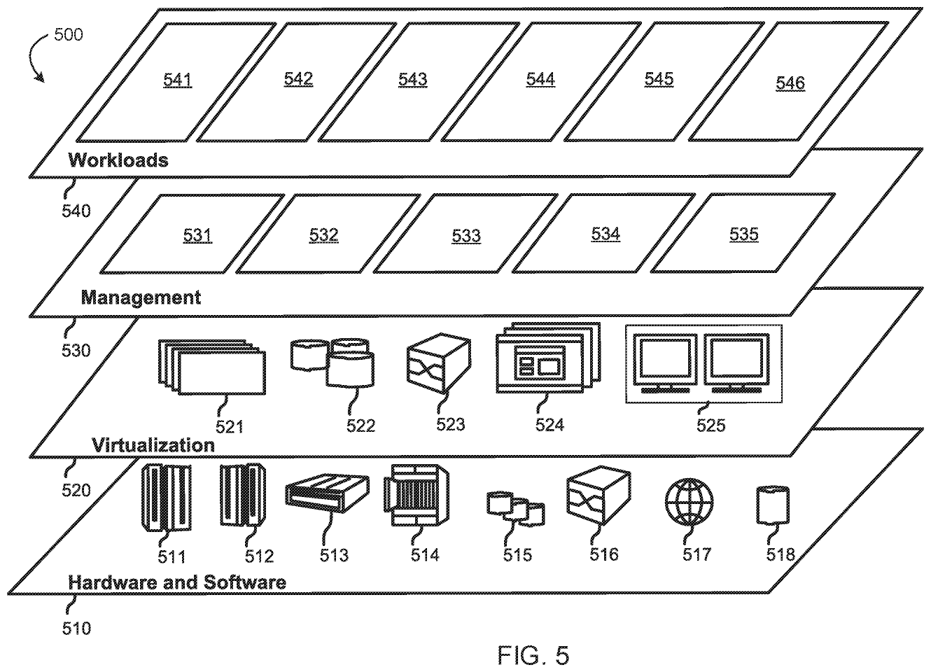

Referring now to FIG. 5, a set of functional abstraction layers 500 provided by cloud computing environment 400 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 510 includes hardware and software components. Examples of hardware components include mainframes 511; RISC (Reduced Instruction Set Computer) architecture-based servers 512; servers 513; blade servers 514; storage devices 515; and networks and networking components 516. In some embodiments, software components include network application server software 517 and database software 518.

Virtualization layer 520 provides an abstraction layer from which the following examples of virtual entities may be provided: virtual servers 521; virtual storage 522; virtual networks 523, including virtual private networks; virtual applications and operating systems 524; and virtual clients 525.

In one example, management layer 530 may provide the functions described below. Resource provisioning 531 provides dynamic procurement of computing resources and other resources that are utilized to perform tasks within the cloud computing environment. Metering and Pricing 532 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 533 provides access to the cloud computing environment for consumers and system administrators. Service level management 534 provides cloud computing resource allocation and management such that required service levels are met. Service Level Agreement (SLA) planning and fulfillment 535 provide pre-arrangement for, and procurement of, cloud computing resources for which a future requirement is anticipated in accordance with an SLA.

Workloads layer 540 provides examples of functionality for which the cloud computing environment may be utilized. Examples of workloads and functions which may be provided from this layer include mapping and navigation 541; software development and lifecycle management 1342 (e.g., the Graph2Seq model 100); virtual classroom education delivery 543; data analytics processing 544; transaction processing 545; and precision cohort analytics 546.

The present invention may be a system, a method, and/or a computer program product at any possible technical detail level of integration. The computer program product may include a computer-readable storage medium (or media) having computer readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a standalone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But the various embodiments may be practiced without these specific details. In other instances, well-known circuits, structures, and techniques have not been shown in detail in order not to obscure embodiments.

When different reference numbers comprise a common number followed by differing letters (e.g., 100a, 100b, 100c) or punctuation followed by differing numbers (e.g., 100-1, 100-2, or 100.1, 100.2), use of the reference character only without the letter or following numbers (e.g., 100) may refer to the group of elements as a whole, any subset of the group, or an example specimen of the group.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure may not be necessary. The previous detailed description is, therefore, not to be taken in a limiting sense.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present invention has been described in terms of specific embodiments, it is anticipated that alterations and modification thereof will become apparent to the skilled in the art. Therefore, it is intended that the following claims be interpreted as covering all such alterations and modifications as fall within the true spirit and scope of the invention.

What is claimed is:

1. A computer-implemented method for subgraph guided knowledge graph question generation, the computer-implemented method comprising:
inputting a knowledge graph subgraph and a target answer into an encoding module, wherein the knowledge graph subgraph is a collection of entities and predicates relating to a domain and represented as nodes for the entities and edges for the predicates;
producing, by the encoding module, embeddings related to the nodes and the edges, wherein each of the nodes and the edges in the subgraph is an embedding represented as an initial vector in an embedding space;
indicating the embeddings associated with the target answer;
applying a graph neural network (GNN) encoder computation in an iterative manner to the embeddings, with updated embeddings produced by the GNN encoder acting as initial values that are applied to the GNN encoder for a next iteration, until final state embeddings are produced;
generating a graph-level embedding based on the final state embeddings; and
computing, by a recurrent neural network (RNN) decoder, a question relating to the target answer and the knowledge graph subgraph using the graph-level embedding.

2. The computer-implemented method of claim 1, wherein applying a GNN encoder computation comprises:
applying, by the GNN encoder, an aggregation function to the embeddings producing a backward aggregation vector and forward aggregation vector;
fusing the embedding with the backward aggregation vector and the forward aggregation vector; and
updating each of the embeddings by incorporating aggregation information relating to neighboring node vectors.

3. The computer-implemented method of claim 1, wherein indicating the embeddings associated with the target answer comprises:
representing the target answer as a learnable markup vector; and
concatenating the initial vector for each of the embeddings with the learnable markup vector.

4. The computer-implemented method of claim 1, wherein the initial vectors for the nodes and the initial vectors for the edges have a same embedding dimension.

5. The computer-implemented method of claim 1, wherein the encoding module is a bidirectional LSTM encoder.

6. The computer-implemented method of claim 1, wherein the GNN encoder is a bidirectional gated graph neural network (BiGGNN) encoder.

7. The computer-implemented method of claim 1, wherein the graph-level embedding is based on a linear projection and a max-pooling of the final state embeddings.

8. The computer-implemented method of claim 1, wherein the target answer is an entity within the collection of entities.

9. A computer program product for subgraph guided knowledge graph question generation, the computer program product comprising:
one or more computer readable storage media, and program instructions stored on the one or more computer readable storage media, the program instructions comprising:
program instructions to input a knowledge graph subgraph and a target answer into an encoding module, wherein the knowledge graph subgraph is a collection of entities and predicates relating to a domain and represented as nodes for the entities and edges for the predicates;
program instructions to produce, by the encoding module, embeddings related to the nodes and the edges, wherein each of the nodes and the edges in the subgraph is an embedding represented as an initial vector in an embedding space;
program instructions to indicate the embeddings associated with the target answer;
program instructions to apply a graph neural network (GNN) encoder computation in an iterative manner to the embeddings, with updated embeddings produced by the GNN encoder acting as initial values that are applied to the GNN encoder for a next iteration, until final state embeddings are produced;
program instructions to generate a graph-level embedding based on the final state embeddings; and
program instructions to compute, by a recurrent neural network (RNN) decoder, a question relating to the target answer and the knowledge graph subgraph using the graph-level embedding.

10. The computer program product of claim 9, wherein program instructions to apply the GNN encoder computation comprises:
program instructions to apply, by the GNN encoder, an aggregation function to the embeddings producing a backward aggregation vector and forward aggregation vector;
program instructions to fuse the embeddings with the backward aggregation vector and the forward aggregation vector; and
program instructions to update each of the embeddings by incorporating aggregation information relating to neighboring node vectors.

11. The computer program product of claim 9, wherein program instructions to indicate the embeddings associated with the target answer comprises:
program instructions to represent the target answer as a learnable markup vector; and
program instructions to concatenate the initial vector for each of the embeddings with the learnable markup vector.

12. The computer program product of claim 9, wherein the initial vectors for the nodes and the initial vectors for the edges have a same embedding dimension.

13. The computer program product of claim 9, wherein the encoding module is a bidirectional LSTM encoder.

14. The computer program product of claim 9, wherein the GNN encoder is a bidirectional gated graph neural network (BiGGNN) encoder.

15. The computer program product of claim 9, wherein the graph-level embedding is based on a linear projection and a max-pooling of the final state embeddings.

16. The computer program product of claim 9, wherein the target answer is an entity within the collection of entities.

17. A system for subgraph guided knowledge graph question generation, the system comprising:
a memory;
a data processing component;
local data storage having stored thereon computer executable program code;
an encoding module configured to produce embeddings relating to nodes and edges from a knowledge graph subgraph and a target answer, wherein the knowledge graph subgraph is a collection of entities and predicates relating to a domain and represented as the nodes for the entities and the edges for the predicates;
a graph neural network (GNN) encoder configured to apply a computation in an iterative manner to the embeddings, with updated embeddings produced by the GNN encoder acting as initial values that are applied to the GNN encoder for a next iteration, until final state embeddings are produced;
a graph line embedder configured to generate a graph-level embedding based on the final state embeddings; and
a recurrent neural network configured to compute a question relating to the target answer and the knowledge graph subgraph using the graph-level embedding.

18. The system of claim 17, wherein the encoding module is a bidirectional LSTM encoder.

19. The system of claim 17, wherein the GNN encoder is a bidirectional gated graph neural network (BiGGNN) encoder.

20. The system of claim 17, wherein the graph-level embedding is based on a linear projection and a max-pooling of the final state embeddings.
